(19) United States
(12) Patent Application Publication
(10) Pub. No.: US 2015/0273942 A1
(43) Pub. Date: Oct. 1, 2015

(54) ADJUSTABLE WHEEL ASSEMBLY FOR AN IRRIGATION SYSTEM

(71) Applicant: LINDSAY CORPORATION, OMAHA, NE (US)

(72) Inventor: Thomas J. Korus, Lindsay, NE (US)

(73) Assignee: LINDSAY CORPORATION, OMAHA, NE (US)

(21) Appl. No.: 14/224,682

(22) Filed: Mar. 25, 2014

(51) Int. Cl. B60B 35/10

(52) U.S. Cl. CPC B60B 35/1036; B60Y 2200/224; B60B 2900/90

(57) ABSTRACT

A wheel assembly for a support structure of a movable irrigation system broadly comprising a rotatable drive component, a motor, a gearbox, and a mount. The mount supports the rotatable drive component, the motor, and the gearbox and is shiftable between first and second orientations. In the first orientation of the mount, the rotatable drive component, the motor, and the gearbox are supported in a first position in which the rotatable drive component traverses a first path. In the second orientation of the mount, the rotatable drive component, the motor, and the gearbox are supported in a second position in which the rotatable drive component traverses a second path spaced from the first path.

### BACKGROUND

The present invention relates to wheel assemblies for movable agricultural irrigation systems.

Movable agricultural irrigation systems such as center-pivot and linear systems are commonly used to irrigate large fields and typically include several irrigation spans mounted on movable support towers. Each movable support tower includes two wheel assemblies configured to traverse a path along the ground for moving the irrigation spans across the fields. After multiple passes of the irrigation system, the path often develops deep ruts in which the wheels of the wheel assemblies can become stuck. The path can be repaired by filling the ruts with soil or other material, but this requires a substantial amount of material, is time consuming, and is difficult to do without damaging crops in the process. Alternatively, the wheels of the wheel assemblies can be replaced with wider wheels for traversing undisturbed ground adjacent to the path, but this requires an additional set of wheels and further damages the path. Moreover, this solution does not work if the current set of wheels is the widest available. Ruts can also be minimized by shifting the center pivot point by a few feet so that the wheel assemblies create a new path, but this results in the destruction of additional crops and may cause the wheel assemblies to become stuck or misaligned when crossing over the worn path. Also, additional pipe and electrical center pivot components must be installed for shifting the center pivot point.

### SUMMARY

The present invention solves the above-described problems and provides a distinct advance in the art of wheel assemblies for irrigation systems. More particularly, the present invention provides a wheel assembly that can be quickly and easily adjusted so as to travel outside worn paths in a field or other area to be irrigated.

An embodiment of the invention is a movable support tower with two wheel assemblies. Each wheel assembly broadly comprises a wheel or other rotatable drive component, a motor, a gearbox, and a mount. The motor and the gearbox are positioned on the mount for providing power to the wheel, and the mount is shiftably attached to the support tower for supporting the wheel, the motor, and the gearbox in first and second orientations. In the first orientation of the mount, the wheel traverses a first path along the ground. In the second orientation of the mount, the wheel traverses a second path spaced from the first path.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a support tower of a movable irrigation system with two adjustable wheel assemblies constructed in accordance with an embodiment of the present invention and shown in a first orientation;

FIG. 2 is a plan view of the support tower of FIG. 1 showing the wheel assemblies of FIG. 1 shifted between the first orientation (solid lines) and a second orientation (dashed lines); and

FIG. 3 is a perspective view of the support tower of FIG. 1 with the adjustable wheel assemblies in the second orientation.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning now to the drawing figures, a movable support structure 10 with first and second adjustable wheel assemblies 12a,b constructed in accordance with embodiments of the invention is illustrated. The movable support structure 10 may be part of an agricultural irrigation system such as a center-pivot or linear irrigation system, a planter, a sprayer, or any other agricultural implement. The movable support structure 10 may join and support movable spans or extensions of the irrigation system that are used to irrigate a field or other area.

The wheel assemblies 12a,b are shiftably mounted near opposite ends of the movable support structure 10 and are shiftable between first and second orientations. The wheel assemblies 12a,b may both be powered, or alternatively, only one wheel assembly may be powered while the other is a follower wheel assembly.

Because the adjustable wheel assemblies 12a,b are essentially identical or are essentially mirrored constructions with respect to each other, only the first wheel assembly 12a will be described in detail.

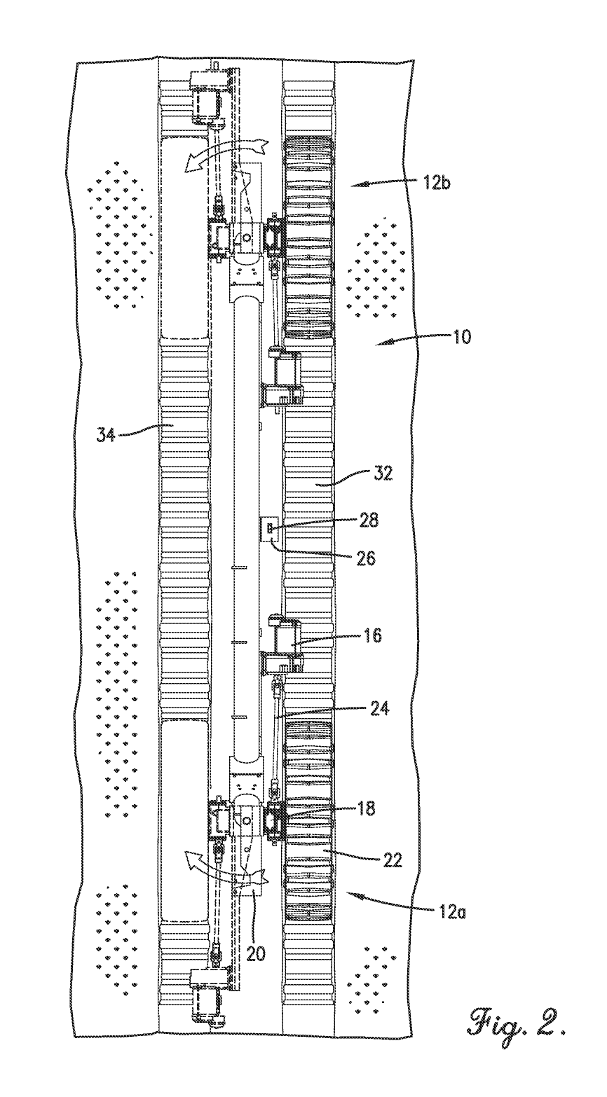

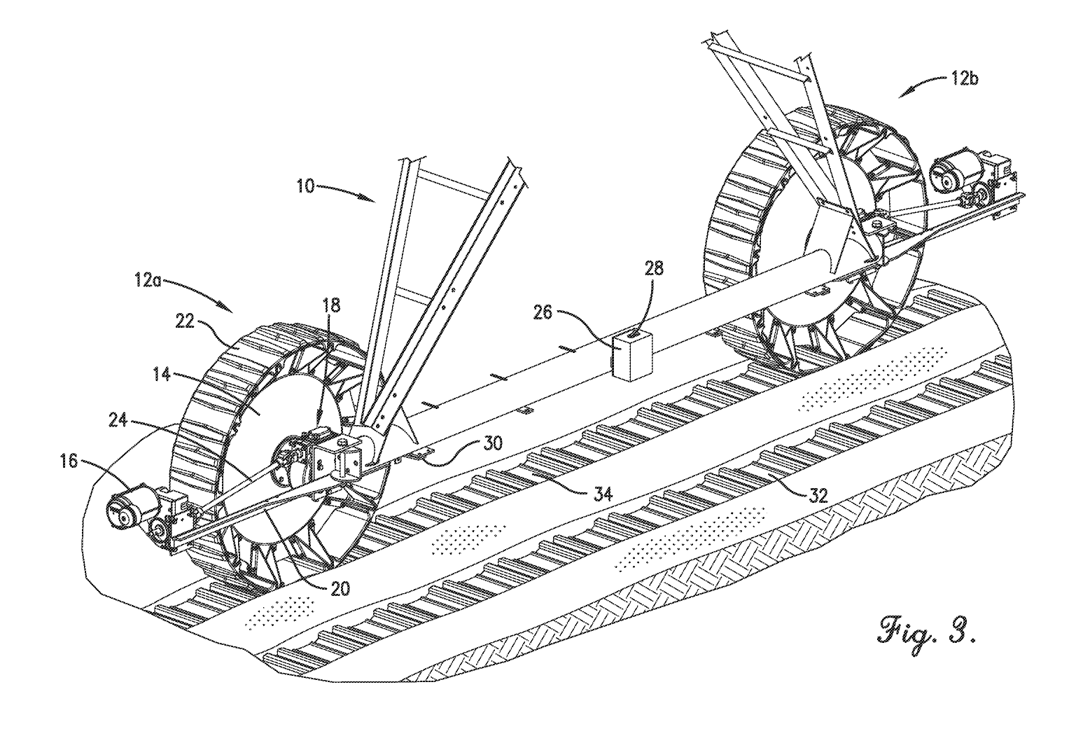

As best shown in FIGS. 2 and 3, the adjustable wheel assembly 12a broadly includes a rotatable drive component 14, a motor 16 and a gearbox 18 drivably connected to the rotatable drive component 14, and a mount 20 shiftably attached to the support structure 10 for supporting the rotatable drive component 14, the motor 16, and the gearbox 18 on the support structure 10 in the first and the second orientation, as described below.

The rotatable drive component 14 may be a wheel, a sprocket, a cog, or other similar component and may include an airless flexible covering 22, a tire, a belt, or interconnected links mounted thereon for improved traction. The rotatable drive component 14 may be approximately 12.5 inches wide.

The motor 16 is attached to the mount 20 and is drivably connected to the gearbox 18 via a rotatable shaft 24. The motor 16 may be configured to receive an electric supply current split at a junction box 26 having a selector switch 28.

The gearbox 18 is attached to the mount 20 and may include gears, belts, worm screws, or any other component for converting high speed rotation of the rotatable shaft 24 to high torque rotation of the rotatable drive component 14. The gearbox 18 may be fixed or variable speed and may include a reverser gear.

The mount 20 is provided for supporting the rotatable drive component 14, motor 16, and gearbox 18 on the support structure 10 in the first and the second orientation and may be translatably attached to the support structure 10 or may be pivotably attached to the support structure 10 at a pivot point by a bolt, pin, or other fastener. The mount 20 may include a locking tab 30 or other component extending from the mount 20 and including interlocking geometry or a lock hole configured to receive a locking pin or a fastener therethrough for securing the mount 20 to the support structure 10 in the first and the second orientation.

The above-described wheel assemblies 12a,b provide several advantages over conventional wheels. For example, the wheel assemblies 12a,b may be shifted between first and second orientations for traversing different paths when the movable support structure 10 follows a trajectory across a field, which reduces wear on the paths and reduces rut formation. The wheel assemblies 12a,b may also be angled or towed with respect to the movable support structure 10 in either orientation for urging the support structure 10 along curved paths.

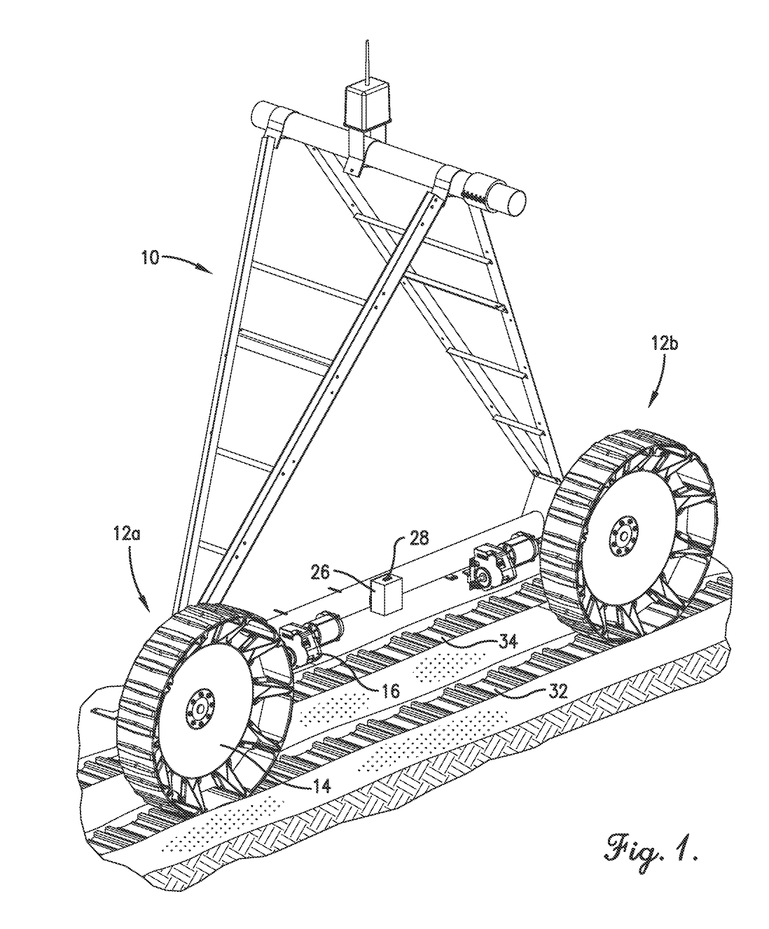

Specifically, the wheel assemblies 12a,b traverse a first path 32 when they are shifted to a first orientation (FIG. 1 and solid line of FIG. 2). The wheel assemblies 12a,b traverse a second path 34 spaced from the first path 32 when they are shifted to a second orientation (FIG. 3 and dashed line of FIG. 2). For example, the mount 20 of the wheel assembly 12a may be pivoted (as shown with curved arrows in FIG. 2) with respect to the movable support structure 10 between the first and the second orientation for pivoting the rotatable drive component 14, the motor 16, and the gearbox 18 between first and second positions, respectively. A locking pin or other fastener may be inserted into the lock hole of the locking tab 30 of the mount 20 and a corresponding lock hole on the support structure 10 to fixedly secure the mount 20, and hence the wheel assembly 12a, in the first or the second orientation.

The mount shifts the wheel assemblies 180 degrees between the first and the second orientations. This causes the rotatable drive component to rotate in the opposite direction when shifted from one orientation to the other orientation. Thus, rotation of the rotatable drive component 14 must be reversed when it is shifted between the two orientations to maintain a consistent trajectory of the support structure 10. This may be achieved by reversing a direction of the rotatable shaft 24 of the motor 16 or by reversing a direction of a rotatable shaft of the gearbox 18. The direction of the rotatable shaft 24 of the motor 16 may be reversed by changing electric phases of the supply current provided to the motor 16 by activating or toggling the selector switch 28 on the junction box 26. Alternatively, the direction of the rotatable shaft of the gearbox 18 may be reversed by engaging the reverser gear of the gearbox 18, which advantageously allows the rotatable shaft 24 of the motor 16 to rotate in a single direction regardless of the orientation of the rotatable drive component 14 and does not require the electric phases of the supply current to be switched.

The rotatable drive component 14 may be positioned outside of the support structure 10 (i.e., “outboard position”) in relation to a center pivot or cart in the first orientation and shifted inside of the support structure 10 (i.e., “inboard position”) in relation to the center pivot or cart in the second orientation. This allows the rotatable drive component 14 to be almost directly underneath the support structure 10 in both orientations. In one embodiment, the mount is configured so that the paths 32, 34 are approximately 24 inches apart.

The wheel assemblies 12a,b may be shifted between the first and the second orientations together or independently of each other. For example, the wheel assemblies 12a,b may both traverse the first path 32 in the first orientation at the same time and may both be shifted to the second orientation for traversing the second path 34 when the first path becomes too worn. Alternatively, the first wheel assembly 12a may continue to traverse the first path 32 in the first orientation when the second wheel assembly 10b is shifted to the second orientation for traversing the second path 34 or vice versa. The movable support structure 10 follows a single trajectory across the field regardless of the orientation of the wheel assemblies 12a,b.

The wheel assemblies 12a,b may also be angled or towed in either orientation with respect to the movable support structure 10. For example, the rotatable drive component 14 may be towed between 0.01 and 10 degrees in relation to the support structure 10 for urging the support structure 10 along curved paths. Rotatable drive components of support structures on inner curved paths (closer to a center pivot of a circular irrigation system) may be towed a greater amount than rotatable drive components on outer curved paths to account for the inner paths having greater curvatures. For the same reason, the rotatable drive component 14 may be towed a greater amount in the second orientation (for traversing the inner or second path 34) than in the first orientation (for traversing the outer or first path 32). However, because the paths 32, 34 have similar curvature, this difference may be negligible.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A wheel assembly for a support structure of an irrigation system, the wheel assembly comprising:
a rotatable drive component;
a motor configured to power the rotatable drive component;
a gearbox configured to transfer power from the motor to the rotatable drive component; and
a mount attached to the support structure for supporting the rotatable drive component, the motor, and the gearbox on the support structure, the mount being shiftable between a first orientation in which it supports the rotatable drive component, the motor, and the gearbox in a first position in which the rotatable drive component traverses a first path and a second orientation in which the mount supports the rotatable drive component, the motor, and the gearbox in a second position in which the rotatable drive component traverses a second path spaced from the first path.

2. The wheel assembly of claim 1, wherein the rotatable drive component is positioned on a first side of the support structure when the mount is shifted to the first orientation and is positioned on a second side of the support structure when the mount is shifted to the second orientation.

3. The wheel assembly of claim 1, wherein the mount is pivotably mounted on the support structure.

4. The wheel assembly of claim 3, wherein the mount is configured to pivot the rotatable drive component, the gearbox, and the motor approximately 180 degrees between the first orientation and the second orientation.

5. The wheel assembly of claim 4, wherein the motor includes a rotatable shaft that may be driven in one direction when the mount is shifted to the first orientation and driven in an opposite direction when the mount is shifted to the second orientation for propelling the support structure in a single direction along the first path or the second path regardless of the orientation of the mount.

6. The wheel assembly of claim 5, further comprising a selector switch for reversing direction of the rotatable shaft.

7. The wheel assembly of claim 1, wherein the first and the second path are curved and the rotatable drive component is configured to be angled between 0.01 and 10 degrees with respect to the support structure in the first and the second orientation for urging the support structure along the first and the second curved path, respectively.

8. The wheel assembly of claim 1, wherein the first and the second path are spaced at least 24 inches from each other.

9. The wheel assembly of claim 1, wherein the rotatable drive component includes a wheel.

10. The wheel assembly of claim 9, wherein the rotatable drive component includes an airless flexible covering mounted on the wheel for providing traction to the wheel.

11. A support structure of an irrigation system including two wheel assemblies each comprising:
a rotatable drive component;
a motor configured to power the rotatable drive component;
a gearbox configured to transfer power from the motor to the rotatable drive component; and
a mount attached to the support structure for supporting the rotatable drive component, the motor, and the gearbox on the support structure, the mount being shiftable between a first orientation in which it supports the rotatable drive component, the motor, and the gearbox in a first position in which the rotatable drive component traverses a first path and a second orientation in which it supports the rotatable drive component, the motor, and the gearbox in a second position in which the rotatable drive component traverses a second path spaced from the first path.

12. The wheel assembly of claim 11, wherein the drive component of each wheel assembly is positioned on a first side of the support structure when the respective mount is shifted to the first orientation and is positioned on a second side of the support structure when the respective mount is shifted to the second orientation.

13. The wheel assembly of claim 11, wherein the mounts are pivotably mounted on the support structure.

14. The wheel assembly of claim 13, wherein each mount is configured to pivot the rotatable drive component, the motor, and the gearbox of the respective wheel assemblies approximately 180 degrees between the first orientation and the second orientation.

15. The wheel assembly of claim 14, wherein each motor includes a rotatable shaft that may be driven in one direction when the respective mount is shifted to the first orientation and driven in an opposite direction when the respective mount is shifted to the second orientation for propelling the support structure in a single direction along the first path or the second path regardless of the orientation of the respective mount.

16. The wheel assembly of claim 14, further comprising a junction box for splitting a supply current to the motors.

17. The wheel assembly of claim 14, further comprising a selector switch for reversing direction of the rotatable shafts.

18. The wheel assembly of claim 1, wherein the rotatable drive components each include a wheel.

19. The wheel assembly of claim 11, wherein the first and the second path are curved and each rotatable drive component is configured to be angled between 0.01 and 10 degrees with respect to the support structure in the first and the second orientation for urging the support structure along the first and the second curved path, respectively.

20. A support structure of an irrigation system, the support structure having two wheel assemblies each comprising:
a wheel;
a motor including a rotatable shaft drivably connected to the wheel and configured to power the wheel;
a gearbox configured to transfer power from the motor to the wheel; and
a mount pivotably attached to the support structure for supporting the wheel, the motor, and the gearbox on the support structure, the mount being pivotable between a first orientation in which it supports the wheel, the motor, and the gearbox in a first position in which the wheel traverses a first path and a second orientation in which it supports the wheel, the motor, and the gearbox in a second position in which the wheel traverses a second path spaced from the first path,
the rotatable shaft being configured to be driven in one direction when the mount is pivoted to the first orientation and driven in an opposite direction when the mount is pivoted to the second orientation for propelling the support structure in a single direction along the first path or the second path regardless of the orientation of the mount.
